(19) United States
(12) Patent Application Publication
(10) Pub. No.: US 2010/0024663 A1
(43) Pub. Date: Feb. 4, 2010

(54) HANDLE FOR A GRILL PAN

(75) Inventor: Weimien Hsu, Fujian (CN)

Correspondence Address: RABIN & Berdo, PC, 1101 14TH STREET, NW, SUITE 500, WASHINGTON, DC, 20005, US

(73) Assignee: TSANN KUEN (CHINA) ENTERPRISE CO., LTD., Fujian (CN)

(21) Appl. No.: 12/531,549

(22) PCT Filed: Mar. 14, 2008
(86) PCT No.: PCT/CN08/00499

§ 371 Date: Sep. 16, 2009

(30) Foreign Application Priority Data
Mar. 16, 2007 (CN) 200720006542.5

(51) Int. Cl. A47J 37/06

(52) U.S. Cl. 99/378

(57) ABSTRACT

A handle for a grill pan, includes a lug fixedly connected with the side of the grill pan and extending outward, wherein the lug is provided with a short shaft. A handle body is pivotally connected to the short shaft; the handle body has an elastic sheet and a tongue extending outward. There are two position state when the handle body is rotated along the short shaft, one is said tongue clamped to the same side edge of the shell of the grill and the elastic sheet in touch with the edge of the lug; the other position state is said tongue detached from the same side edge of the shell of the grill and the elastic sheet is detached from the edge of the lug.

### FIELD OF THE INVENTION

The present invention relates to an accessory of electric grill.

### BACKGROUND OF THE INVENTION

Conventional grills have a metal reflecting plate on the opening surface of the shell made of insulation material, a window is opened in the center of the reflecting plate, and a heat plate is disposed in the window; the heat plate, the reflecting plate and the shell defined a close space in which an electric heating tube is disposed in, the electric heating tube is fixed to the heating plate. The grill pan is detachably mounted on the outer surface of the heat plate. The top surface of the pan is the grilling surface. In cleaning, the pan must be taken down from the heat plate of the shell; to move the pan, each sides of the pan has a handle extending outward respectively, the user can hold the two handles by two hands respectively to take up the pan. If the pan can not be fixed to the heat plate, the pan will be swift to affect the using, thus a fastener supported by a spring is mounted in each handle respectively, the pan is fixed to the heat plate by the fastener clamping on the shell. When the pan is to be taken down from the heat plate of the shell, push the connecting member of the fastener to compress the spring, the fastener will be withdrawn from the shell; when the pan is to be fixed to the heat plate of the shell, release the connecting member of the fastener, the fastener will be clamped to the shell by the restoring force of the spring. Although the abovementioned structure has overcome the problem of taking down the pan and fixed the pan to the heat plate, it still has the following drawbacks: the handle is not enough cooperative with the fastener in using. In addition, the handle and fastener have many parts, which causes high cost in manufacture and assembly.

### SUMMARY OF THE INVENTION

The object of the present invention is to provide a handle for grill pan, which has both the function of handle and the function of fastener, and can be used conveniently and lower manufacture cost.

This object of the present invention is achieved by providing: a handle for a grill pan includes a lug fixedly connected with the side of the grill pan and extending outward, said lug is provided with a short shaft; a handle body pivotally connected to said short shaft; the handle body has an elastic sheet and a tongue extending outward; There are two position state when the handle body is rotated along the short shaft, one is said tongue of the handle body clamped to the same side edge of the shell of the grill and the elastic sheet in tough with the edge of the lug; the other position state is said tongue detached from the same side edge of the shell of the grill and the elastic sheet is detached from the edge of the lug.

A preferred structure of the handle body is that: said handle body is configured to be a flat box with an opened bottom and an opened side, the tongue is extended out from the side opening of the concave, two extending-downward protrusions and an extending-downward elastic sheet are disposed in the lower surface of the concave, the two protrusion are arranged between the side opening and the elastic sheet; said lug insert into the concave via the side opening of the handle body, the two ends of the short shaft pivotally connected to the two protrusions respectively. The handle body can be one-step mold by pressure injection.

Further, a C-shaped inner cover board which covering the said concave is mounted on the two protrusions of said handle body, the C-shaped opening of the inner cover board is corresponding to the said lug and the width of the C-shaped opening is slightly wider than the width of said lug. The inner cover board can improve the appearance of the handle and facilitate the cleaning in using.

Particularly, the inner surface of said C-shaped inner cover board has an extending-upward protrusion in each of the two sides of the C-shaped opening respectively, said extending-upward protrusion is corresponding to one extending-downward protrusion of the concave of the handle body respectively; each of the two protrusions of the inner cover board and each of the two protrusions of the handle body has a half-circle groove in the connecting surface respectively to form the pivotal hole for the two ends of the short shaft of the pan. The half-circle grooves of the connecting surfaces of the two protrusions of the inner cover board and the two protrusions of the handle body are formed the pivotal holes for receiving the two ends of the short shaft of the pan respectively; which can one-step mold in injection to reduce the process of boring holes.

Further more, each of the protrusions of said inner cover board has a via hole disposed in the outside of the half-circle groove respectively, each of the two protrusions of the handle body has a screw hole corresponding to said via hole in the outside of the half-circle groove; two screws are pass through the two via holes of the inner cover board and screwed in the two screw hole of the handle body respectively. This structure is also one-step mold, the inner cover board is fixed to the handle body by screw, the installing process is very simple.

A handle for a grill pan of the present invention is provided with a lug which is fixedly connected with the side of the pan and extending outward, said lug is provided with a short shaft; a handle body is pivotally connected to said short shaft; the handle body has an elastic sheet and a tongue extending outward; when the handle body is at the position state that the handle body rotated relative to the short shaft, the tongue of the handle body is clamped to the same side edge of the shell of the grill, and the elastic sheet of the handle body is connected to the edge of the lug in interference; when the handle body is at another position state that the handle body rotated relative to the short shaft, the tongue of the handle body is detached from the same side edge of the shell of the grill, and the elastic sheet of the handle body is detached from the edge of the lug. The pan can be moved freely by the assembled handle. The handle achieves the object of having both the function of handle and the function of the fastener by the tongue being clamped to or detached from the shell of the grill in the two position states of the handle body rotated relative to the short shaft of the lug. The operation of the handle body clamped to or detached from the shell of the grill is simple and quickly, and is meet with the habit of the hands. The lug can be molded on the pan directly, both the handle body and the C-shaped inner cover board can be one-step mold by injection; the handle has less parts and is easy to be manufactured, thus can reduce the manufacture cost greatly compared to the prior art. Because when the inner cover board is fixed to the handle body by screw, the handle body is pivotally connected to the short shaft of the lug at the same time, thus the install is very simple

### BRIEF DESCRIPTION OF THE DRAWINGS

FIG. 1 is a perspective view of a double-sided grill provided with the handles of the present invention.

FIG. 2 is an exploded view of the upper portion of the grill of the double-sided grill of FIG. 1.

FIG. 3 is an enlarged view of the A portion of the FIG. 2.

FIG. 4 is a top view of the double-sided grill of FIG. 1 illustrating that the upper portion is in released state.

FIG. 5 is a sectional view taken along B-B of the FIG. 4.

FIG. 6 is an enlarged view of the C-portion of FIG. 5.

FIG. 7 is a sectional view of the double-sided grill of FIG. 1 illustrating that the upper portion is in locked state.

FIG. 8 is an enlarged sectional view of the D portion of FIG. 7.

### DETAILED DESCRIPTION OF THE PREFERRED EMBODIMENT

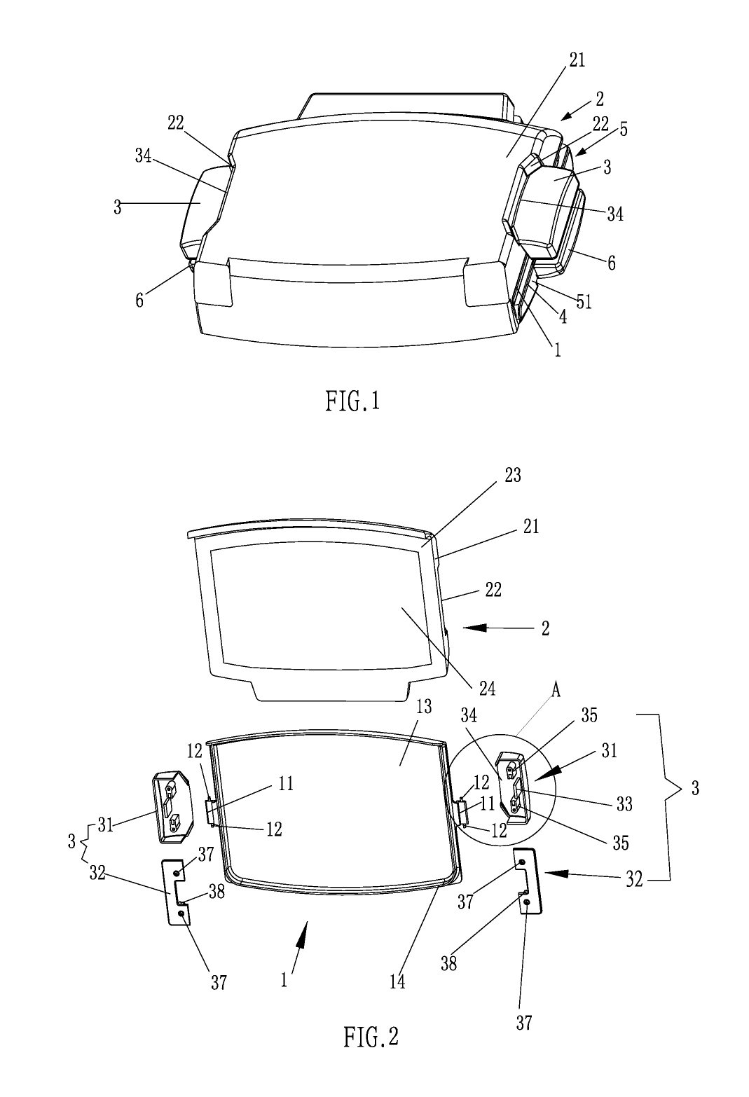

Referring to FIG. 1, which is a perspective view of a double-sided grill provided with the handles of the present invention, the double-sided grill includes an upper grill portion 2 and a lower grill portion 5, the pan 1 of the upper grill portion 2 is fixedly clamped to the upper shell 21 by the two handles 3 which are mounted to the left and right sides respectively. The pan 4 of the lower grill portion 5 is fixedly clamped to the lower shell 21 by the two handles 6 which are mounted to the left and right sides respectively.

The components of the upper grill portion 2 are shown in FIG. 2, the shell 21 of the upper grill portion 2 is made of insulation bakelite; the left side and right side each has an inserting concave 22. A reflecting board 23 made of aluminum alloy is disposed on the opening surface of the shell 21, the center of the reflecting board 23 opened a window in which a heat plate 24 made of aluminum alloy is disposed in. The heat plate 23, the reflecting plate 24 and the shell 21 defined a close space in which an electric heating tube is disposed in, the electric heating tube is fixed to the heating plate 24. The grill pan 1 is detachably mounted on the lower surface (the front surface in FIG. 2) of the heat plate 24.

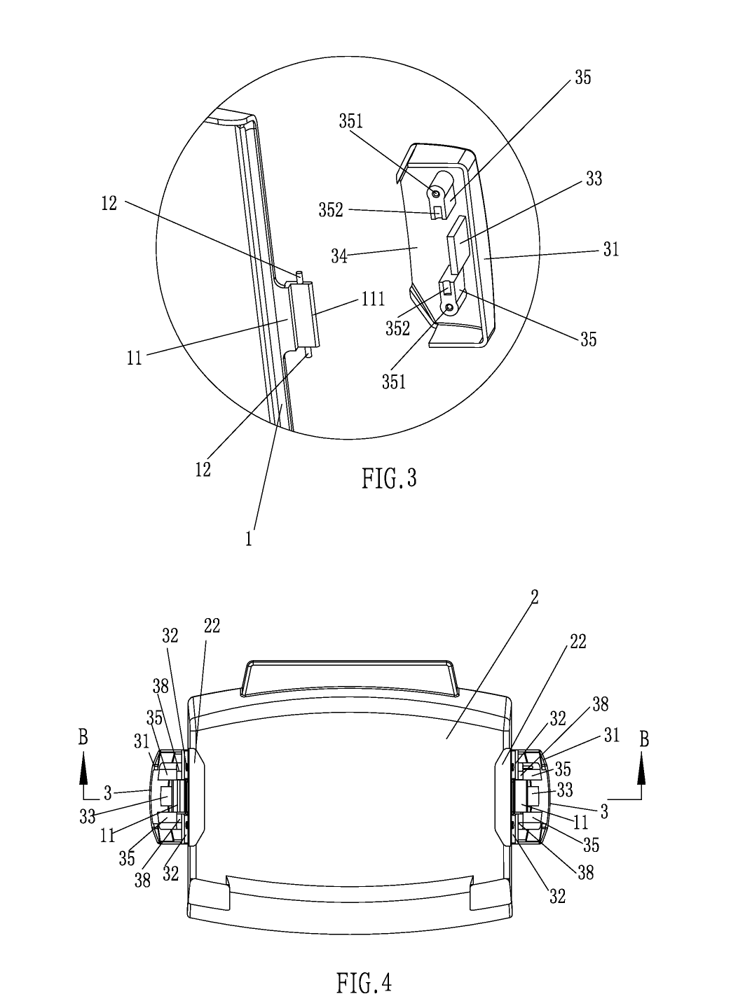

The grill pan 1 is approximately a rectangle made of aluminum alloy, the left and right sides each extended out a lug 11, each lug 11 has a short shaft 12, the lower surface (the front surface in FIG. 2) is the grilling surface 13, an annular periphery wall 14 extended downwardly (forwardly in FIG. 2) from the edges of the grilling surface 13. Each short shaft 12 of the lugs in the left and right side pivotally connected with a handle body 31. Referring to FIG. 3, each handle body 31 is formed to be a flat box with an opened bottom and an opened side and is formed by one-step mold of pressure injection; the tongue 34 is extended out from the side opening of the concave of each handle body 31, two extending-downward protrusions 35 and an extending-downward elastic sheet 33 are disposed in the lower surface of the concave, the two protrusion 35 are arranged between the side opening and the elastic sheet 33; each of the top surfaces of the two protrusions has a screw hole, and the opposite sides of the two protrusions 35 each has a half-circle groove 352 respectively, a C-shaped inner cover board 32 which covering the said concave is mounted on the two protrusions 35 of said handle body 31.

The inner cover board is one-step mold by injection, and the C-shaped opening of the inner cover board is corresponding to the said lug 11 and the width of the C-shaped opening is slightly wider than the width of said lug 11, the inner surface of said inner cover board 32 has two extending-upward protrusion 38 in the two sides of the C-shaped opening respectively, each extending-upward protrusion 38 is corresponding to one protrusion 35 extending downwardly of the concave of the handle body 31 respectively; each of the two protrusions 38 of the inner cover board 32 has a via hole 37 which is corresponding to the screw hole 351 of the protrusion 35 of the handle body 31. Each of the opposite sides of the two protrusions 38 of the inner cover board 32 has a half-circle groove respectively.

In assembly, insert the lug 11 of the grill pan 1 into the concave via the side opening of the handle body 31, then align the two protrusions 38 of the inner cover board 32 to the two protrusions 35 of the handle body; the two protrusions 38 of the inner cover board 32 and the two protrusions 35 of the handle body formed a pivotally connecting hole the in the connecting surface for receiving the two ends of the short shaft 12, two screws are pass through the two via holes 37 of the inner cover board 32 and screwed in the two screw hole 351 of the handle body 31, the inner cover board 32 is fixed to the handle body 31 by two screws, this assembly is very simple.

The grill pan 1 with assembled handles can be taken up by holding the two handles with two hands by user so as to be mounted to the upper grill portion 2 of this embodiment; or be detached from the heat plate 24 of the upper grill 2 in cleaning.

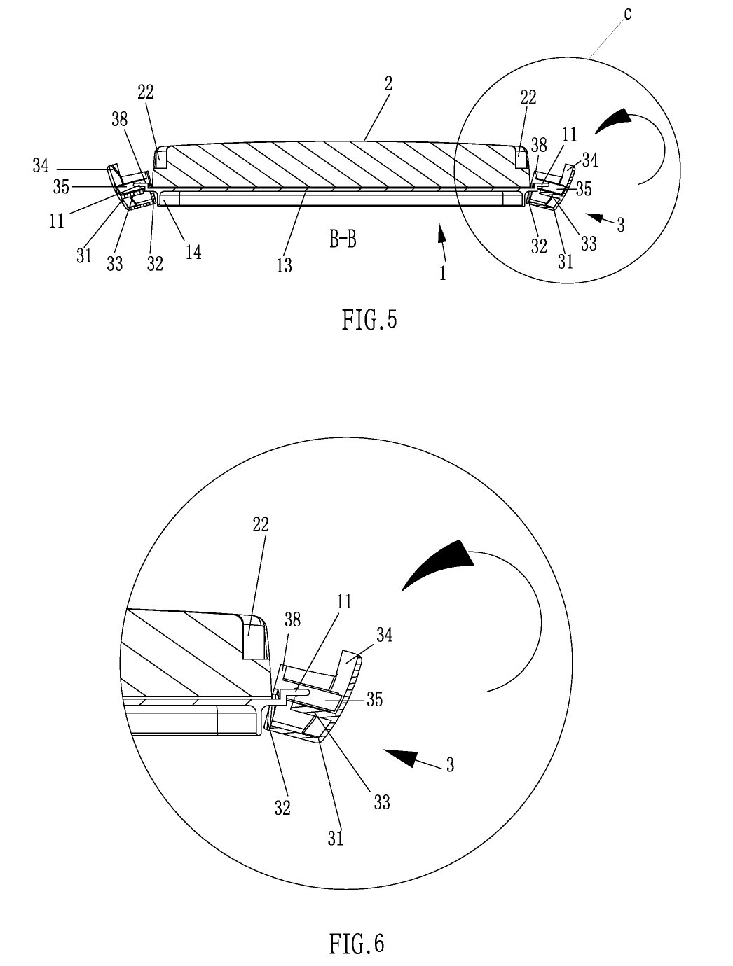

The top view of the structure of the grill pan 1 with assembled handles and the upper grill portion 2 in released states is shown in FIG. 4. In this state, the sectional structure of the structure of the grill pan 1 with assembled handles and the upper grill 2 in released state is shown in FIG. 5 and FIG. 6, in this state the tongue 31 of the handle body 31 is detached from the concave 22 in the same side of the shell 21 of the upper grill 2, and the elastic sheet 31 of the handle body 31 detached from the lug 11 of the pan 1.

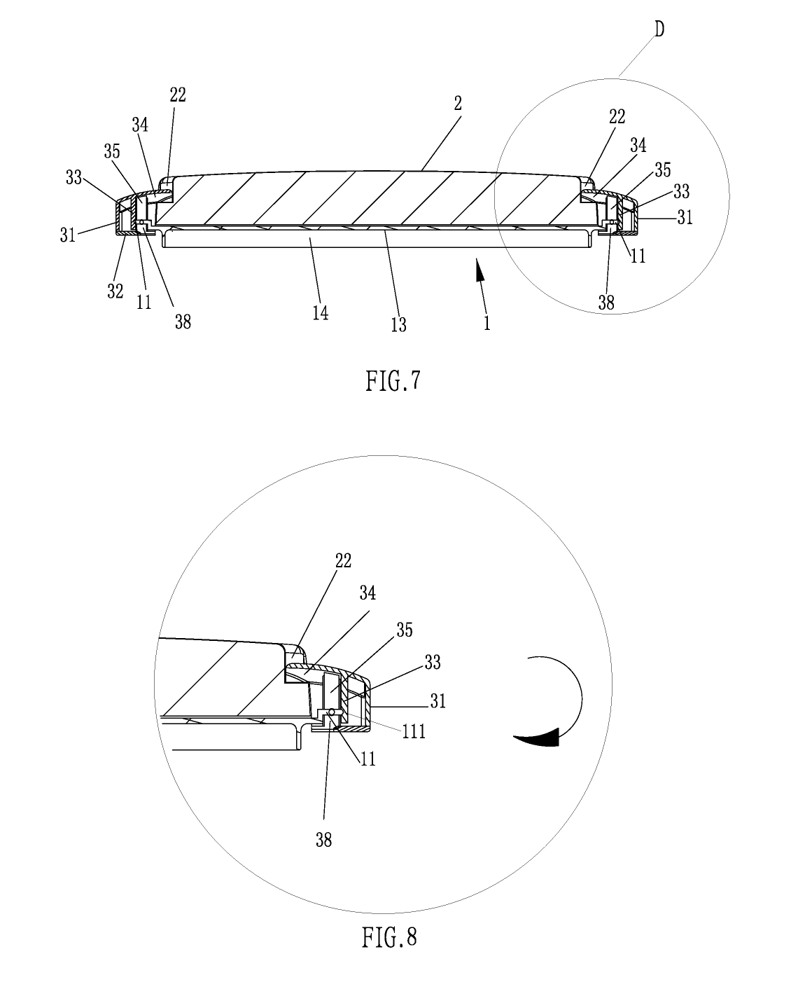

As pointed out by the arrow of FIG. 6, rotate the handle body 31 of the two sides of the grill pan 1 inwardly and upwardly relative to the short shaft 12 to the lock position of the FIG. 7 Then referring to FIG. 8, the tongue 34 of the handle body 31 inserted into the concave 22 in the same side of the shell 21 of the upper grill 2, and the elastic sheet 33 of the handle body 31 connected to the edge 111 of the lug 11 of the grill pan 1 in interference; thus the grill pan 1 is fixed with the heat plate 24 of the upper grill 2 and will not swift. The perspective structure of the pan 1 with assembled hands and the upper grill 2 is shown in FIG. 1. Referring to the arrow of the FIG. 8, rotate the handle body 31 of the two sides of the pan 1 inwardly and downwardly relative to the short shaft 12, then will return to the released state in FIG. 5.

### INDUSTRIAL APPICABILITY

The operation of the handle body clamping to or detached from the shell of the grill is simple and quickly, and is meet with the habit of the hands. The lug can be molded on the pan directly, the C-shaped inner cover board can be one-step mold by injection; it has less parts and easy to be manufactured, thus can reduce the manufacture cost greatly compared to the prior art. Because when the inner cover board is fixed to the handle body by screw, the handle body is pivotally connected to the short shaft of the lug at the same time, the install is very simple.

Although an exemplary embodiment of the present invention has been shown and described, it would be appreciated by those skilled in the art that changes may be made in this embodiment without departing from the principles and spirit of the invention, the scope of which is defined in the claims and their equivalents.

What is claimed is:

1. A handle for a grill pan, comprising:
a lug, provided with a short shaft, fixedly connected with the side of the grill pan and extending outward;
a handle body pivotally connected to said short shaft; wherein said handle body has an elastic sheet and a tongue extending outward; wherein said handle body can rotate along said short shaft and comprises two position state, one position state is said
tongue clamped to the same side edge of the shell of the grill and the elastic sheet in touch with the edge of the lug and the other position state is said tongue detached from the same side edge of the shell of the grill and the elastic sheet is detached from the edge of the lug.

2. The handle for a grill pan according to claim 1, wherein said handle body is configured to be a flat box with an opened bottom and an opened side, said tongue is extended out from the side opening of the concave, two extending-downward protrusions and an extending-downward elastic sheet are disposed in the lower surface of the concave, the two protrusion are arranged between the side opening and the elastic sheet; said lug insert into the concave via the side opening of the handle body, the two ends of the short shaft pivotally connected to the two protrusions respectively.

3. The handle for a grill pan according to claim 2, wherein a C-shaped inner cover board covering said concave is mounted on the two protrusions of said handle body, the C-shaped opening of the inner cover board is corresponding to the said lug and the width of the C-shaped opening is slightly wider than the width of said lug.

4. The handle for a grill pan according to claim 3, wherein the inner surface of said C-shaped inner cover board has an extending-upward protrusion in each of the two sides of the C-shaped opening respectively, said extending-upward protrusion is corresponding to said extending-downward protrusion of the concave of the handle body respectively; each of the two protrusions of the inner cover board and each of the two protrusions of the handle body has a half-circle groove in the connecting surface respectively to form the pivotal holes for receiving the two ends of the short shaft of the pan respectively.

5. The handle for a grill pan according to claim 4, wherein each of the protrusions of said inner cover board has a via hole disposed in the outside of the half-circle groove respectively, each of the two protrusions of the handle body has a screw hole corresponding to said via hole in the outside of the half-circle groove; two screws are pass through the two via holes of the inner cover board and screwed in the two screw hole of the handle body respectively.
